(19) United States
(12) Patent Application Publication
(10) Pub. No.: US 2005/0150097 A1
(43) Pub. Date: Jul. 14, 2005

(54) Cold process for joining metal

(76) Inventors: Ronald E. Jones, Racine, WI (US); John E. Baker JR., Racine, WI (US); Patrick J. McCarthy, Franklin, WI (US); Jon E. Lindquist, Kenosha, WI (US)

Correspondence Address: JANSSON, SHUPE & MUNGER, LTD, 245 MAIN STREET, RACINE, WI, 53403, US

(21) Appl. No.: 10/754,282

(22) Filed: Jan. 9, 2004

(51) Int. Cl. B23P 11/00; B21D 39/00

(52) U.S. Cl. 29/506; 29/505; 29/509

(57) ABSTRACT

This invention is directed to a method for joining, by axial movement, inner and outer metal pieces having different hardnesses. The method involves forming the harder piece to have a radial groove in its juncture surface. The harder piece has leading and trailing portions on either side of the radial groove. The leading portion is dimensioned to permit it to slide with respect to the softer piece and the trailing portion is dimensioned for swaging interference with the softer piece. Relative male-female axial movement is imparted to the pieces, thereby urging the junction surface of the softer piece along the leading portion of the harder piece until the softer piece engages the trailing portion of the harder piece. Relative axial force is applied for continued axial movement whereby the softer piece is forced past the groove such that swaging interference causes a portion of the softer piece to be upset into the groove, thereby creating a permanent joint between the pieces.

### FIELD OF THE INVENTION

This invention is related generally to joining two metal components particularly, two metal components of different hardnesses.

### BACKGROUND OF THE INVENTION

It is often necessary to join metals of two different hardnesses. An example of such an application is the joining a plate-like flywheel to a gear within a clutch assembly such that the combination would be able to carry a torsional load without the possibility of axial separation within the tolerance of potential axial force.

A frequently-used joining process is conventional welding. Conventional welding, however, requires high temperatures over a broad area, and such levels of heat cause thermal deformation. In low-tolerance applications, such deformation is unacceptable. Moreover, conventional welding requires highly skilled manual labor or expensive robotics to be accomplished.

Electron beam welding is generally acceptable for purposes of joining two metals without the deformation problems experienced through heat application by means of conventional welding. Beam welding, however, is expensive.

Aside from joining through the use of heat, the other joining methods involve the use of connectors such as bolts, studs, or rivets. The use of connectors, when logistically possible, involves the removal of material with the resultant weakening of the components.

An inexpensive method of permanent joining two metals without the possibility of thermal deformation would be an important improvement in the art.

### OBJECTS OF THE INVENTION

It is an object of the invention to provide a method of permanently attaching a two metal components together that overcomes some of the shortcomings of the prior art.

Another object of this invention is to provide a method to join two metals of different hardnesses.

It is another object of this invention to join two metal components without the addition of heat.

It is a further object of this invention to provide a method for joining two metals of different hardnesses without thermal deformation of either component.

It is another object of this invention to provide a method of joining two metal components through the use of a press without the need for highly-trained welders.

It is still another object of the invention to provide a method for making a high-tolerance metal joint without the necessity of using expensive welding techniques.

Yet another object of this invention is to provide a method for joining metals of two different hardnesses without the need to drill a connector hole between the two components.

These and other important objects will be apparent from the following descriptions of this invention which follow.

### SUMMARY OF THE INVENTION

This invention involves a method for joining, by axial movement, inner and outer metal pieces having different hardnesses. In this context, the term “hardness” refers to the relative ability of two metals to resist shearing and to withstand the tendency to deform and plastically flow when placed under similar temperature and pressure conditions. The inner piece has an outward juncture surface. The outer piece has an inward juncture surface. The method involves forming the harder piece to have a radial groove in its juncture surface. The harder piece has leading and trailing portions on either side of the radial groove. The leading portion is dimensioned to permit it to slide with respect to the softer piece and the trailing portion is dimensioned for swaging interference with the softer piece. The method further involves the imparting relative male-female axial movement of the pieces, thereby urging the junction surface of the softer piece along the leading portion of the harder piece until the softer piece engages the trailing portion of the harder piece. The method further involves the applying of relative axial force for continued axial movement whereby the softer piece is forced past the groove such that swaging interference causes a portion of the softer piece to be upset into the groove, thereby creating a permanent joint between the pieces.

In one version of this method, the harder piece is the inner piece.

In the version where the harder piece is the inner piece, it is preferable for the force-applying step to be further comprised of the substeps of fixing the relative position of the inner piece, and applying axial force to the outer piece.

Alternatively, in the version where the harder piece is the inner piece, it is preferable for the force-applying step to be further comprised of the substeps of fixing the relative position of the outer piece, and applying axial force to the inner piece. In another version where the harder piece is the inner piece, it is preferable for the outward and inward juncture surfaces to have a substantially circular radial cross-section.

Yet another version of this method the harder piece is the outer piece. It is yet more preferable for the force-applying step to be further comprised of the sub steps of fixing the relative position of the inner piece, and applying axial force to the outer piece. Alternatively, the force-applying step may be further comprised of the sub-steps of fixing the relative position of the outer piece, and applying axial force to the inner piece.

In the version of this method where the harder piece is the outer piece, it is preferable for the outward and inward juncture surfaces to have a substantially circular radial cross-section.

Another aspect of the invention is a method for joining a cylinder of a first metal of a first hardness to a second-metal component of a second hardness. The cylinder is harder than the second-metal component. The term cylinder is used in the broadest sense, including hollow and solid core, and including non-circular, radial cross-sectional shapes. The method comprises several steps. One of the steps is providing a cylinder which has an axis, a proximal section with a radial cross-sectional shape of a first dimension, a distal section of the radial cross-sectional shape, said distal section of a second dimension greater than the first dimension; and a groove section of the radial cross-sectional shape, said groove section of a third dimension less than the first dimension, said groove section located between the proximal section and the distal section, thereby defining a ledge with a sharp, discrete edge at a line of juncture between the groove section and the distal section and further thereby defining a groove. Another step is providing the second-metal component with an aperture of the radial cross-sectional shape. The aperture has a dimension greater than the first dimension and less than the second dimension. This second-metal component further has a radial dimension greater than the second dimension, an upper surface and a lower surface. Another of the steps in the method is mounting the second-metal component onto the cylinder such that a portion of the first section is located within the aperture and such that the lower surface is distal to the upper surface proximal to the ledge. The final step is applying axial force to move the cylinder with respect to the second-metal component such that the lower surface is urged distally to a position distal to the groove section. In this way, the ledge cuts an interior portion of the second-metal component adjacent to the aperture, and the upsets the cut interior portion into the groove, thereby creating a joint.

The axial force may be applied with respect to the upper surface or with respect to the distal section of the cylinder.

In a preferred version of this aspect of the invention, the radial cross-sectional shape is generally circular. It is more preferable for the cylinder to be a hub with longitudinal splines extending along at least a portion of the proximal section and extending along at least a portion of the distal section, such that the splines maintain a regular radial distance from the axis, and wherein the second-metal component has spline-receiving slots extending radially out from the aperture configured and arranged to be complementary to the splines when the second-metal component is mounted on the cylinder. It is more preferable for the longitudinal splines to be helical.

In this version of this aspect of invention, the second-metal component is a disk.

In yet another version of this method, the groove has a longitudinal cross-section which is bulbous with a larger end interior to a narrow end. It is more preferable if the groove section is configured and arranged to direct the interior portion of the second-metal component upset by the ledge into compact and filling engagement with the groove.

Another aspect of the invention is a method for joining a cylinder of a first metal of a first hardness to a second-metal component of a second hardness. This method comprises several steps. First, two metal components are provided. The first component is a cylinder of the first metal. The term cylinder is used in the broadest sense, including hollow and solid core, and including non-circular, radial cross-sectional shapes. The cylinder has an axis, a radial cross-sectional shape of a first dimension, an exterior surface, a proximal end, and a distal end. The second-metal component has an aperture of the radial cross-sectional shape, complementary to the cross-sectional shape of the cylinder. The second-metal component has an upper surface, a lower surface, and an aperture wall extending longitudinally adjacent to the aperture from the upper surface to the lower surface. The aperture wall has an upper section of the radial cross-sectional shape with a second dimension greater than the first dimension extending from the upper surface toward the lower surface, a lower section of the radial cross-sectional shape with a third dimension less than the first dimension extending from the lower surface toward the upper surface, and a groove section of the radial cross-sectional shape, said groove section of a fourth dimension greater than the second dimension, said groove section extending between the upper section and the lower section, thereby defining a ledge with a sharp, discrete edge at a line of juncture between the groove section and the lower section and further thereby defining a groove. Another of the steps to this method is mounting the second-metal component onto the proximal end of the cylinder such that the proximal end of the cylinder is located within the upper section of the aperture and such that the upper surface is oriented toward the distal end. Axial force is then applied to move the cylinder with respect to the second-metal component such that the upper surface is urged distally; thereby allowing the ledge to cut a portion of exterior surface of the cylinder, and allowing the ledge to upset the cut portion of the exterior surface into the groove creating a joint.

In versions of the method, it is preferable for the axial force to be applied with respect to the lower surface or with respect to the distal end of the cylinder.

It is another preferable version of this aspect of the invention for the radial cross-sectional shape to be generally circular. It is preferable for the cylinder to further have longitudinal splines extending along at least a portion of an exterior surface of the cylinder, such that the splines maintain a regular radial distance from the axis, and wherein the second-metal component further defines spline-receiving slots extending radially out from the aperture, configured and arranged to be complementary to the splines when the second-metal component is mounted on the cylinder. It is more preferable for the longitudinal splines to be helical.

It is another preferable version of this aspect of the invention to have the second-metal component to be a disk.

In another preferable version of this aspect of the invention, the groove has a longitudinal cross-section which is bulbous with a larger end interior to a narrow end.

It is more preferable if the groove is configured and arranged to direct the portion of the exterior surface upset by the ledge into compact and filling engagement with the groove.

Yet another aspect of this invention is a method for joining a first-metal component of a first hardness to a second-metal component of a second lesser hardness. The method comprises the steps of (a) providing a first wall on the first-metal component, having: first and second edges; a smooth first surface extending from the first edge toward the second edge along a straight direction of travel; a smooth second surface extending from the second edge toward the first edge along the same direction of travel, the second surface being parallel to and offset from the first surface, thereby creating a shoulder; and a groove between the first and second surfaces; (b) providing a second wall on the second-metal component, having a straight smooth third surface and a fore edge; (c) placing the third surface in contact with the first surface such that the fore edge is located between the first edge and the shoulder; (d) continually forcing the first-metal and second-metal components together such that the third and first surfaces remain in contact; and (e) while such continued contact force is applied, applying sliding force to impart relative sliding motion of the first-metal and second-metal components along the direction of travel such that the fore edge is urged toward the second edge to a position beyond the groove, thereby causing the shoulder to upset a portion of the second-metal component into the groove; whereby the first-metal and second-metal components are fixed in their relative positions along the direction of travel.

### BRIEF DESCRIPTION OF THE DRAWINGS

FIG. 1 is a perspective cross-section of two materials of different hardness attached to each other through this method.

FIG. 2A is an expanded view of the interface between the harder metal and softer metal before integrating engagement.

FIG. 2B is the interface of FIG. 2A in an intermediate phase of integration.

FIG. 2C is the interface of FIG. 2A at the conjunction.

FIG. 3A is a top view of one particular embodiment of an application of the process where the components are respectively splined.

FIG. 3B is a partial cut-out of FIG. 3A taken along the lines 3B-3B.

FIG. 4A is a cross-section of a tool/die to accomplish the function of this particular method.

FIG. 4B is an expanded cross-section of FIG. 4A taken along the circle 4B-4B of FIG. 4A.

FIG. 4C is a partial expanded view of the interface of FIG. 4B taken along the line 4C-4C of FIG. 4B.

FIG. 5A is a cross-section of another type of press to carry out a function of this method.

FIG. 5B is an expanded cross-section of FIG. 5A taken along the circle 5B-5B of FIG. 5A.

FIG. 5C is an expanded view of the interface of FIG. 5B taken along the line 5C-5C of FIG. 5B.

FIG. 6A is a cross-section of a tool/die to carry out the method of this invention.

FIG. 6B is an expanded cross-section of FIG. 6A taken along the lines of 6B-6B of FIG. 6A.

FIG. 6C is an expanded view of the interface of FIG. 6B taken along the line 6C-6C of FIG. 6B.

FIG. 7 is yet another embodiment of the invention where the inner core is being attached to a harder metal outer core.

FIG. 8 is a top view of two metals joined together having a square interface.

FIG. 9 is a side view of yet another application of the method of attaching two metals of different hardness in a retaining form.

FIG. 10 is a top view of the method of FIG. 9.

### DETAILED DESCRIPTIONS OF THE PREFERRED EMBODIMENTS

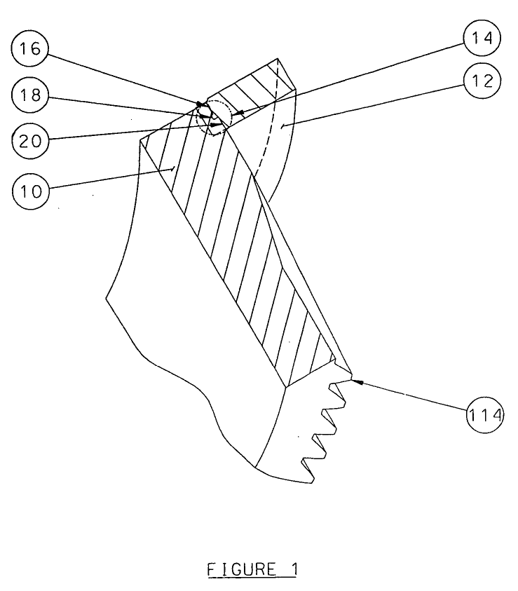

FIG. 1 shows a partial cross-section of a flywheel assembly combination of two components, each of a different metal joined, together through this inventive process. The two metals formed to create the flywheel are a splined-hub harder component 10 and the disk-like softer component 12. Specifically, a harder component 10 is attached to a softer component 12 along an interface 14. It will be recognized in this context that the terms “harder” and “softer” refer to relative malleability between the two metals.

Interface 14 has an upper portion 16, a central portion 18, and a lower portion 20. With respect to the planar cross-section, upper and lower portions 16, 20 have linear aspects and are parallel but not collinear. Central portion 18 is nonlinear but provides a continuous surface between upper and lower portions 16, 20.

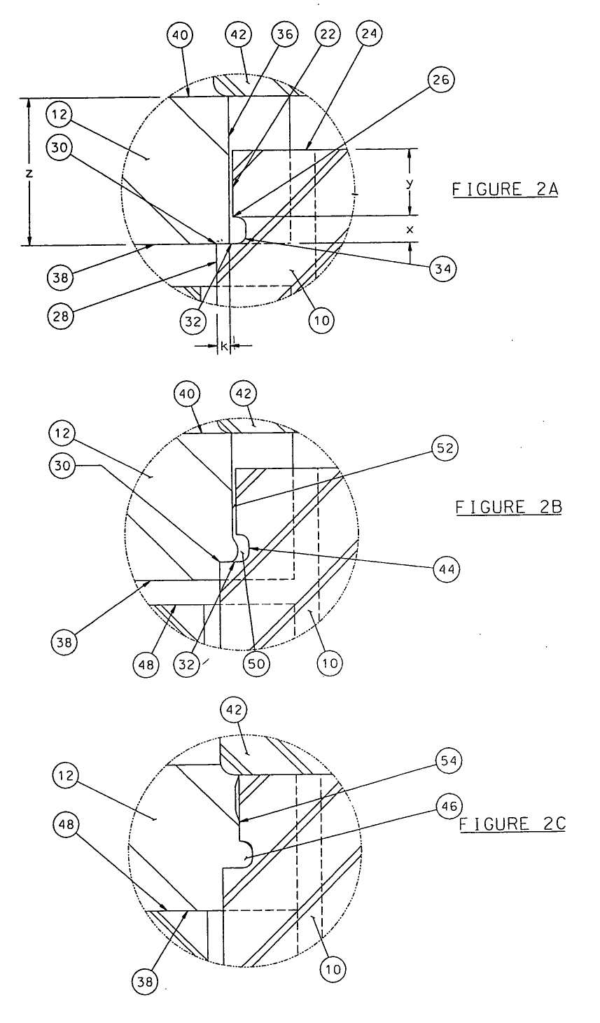

FIGS. 2A, 2B, and 2C show the process in stages at interface 14. As seen in FIG. 2A, harder component 10 has a vertical, hard upper engaging surface 22 extending from a horizontal top surface 24 to hard-upper-engaging-surface end edge 26. The terms “vertical” and “horizontal” are used here for ease of discussing the figures on the drawing sheets; in application, the process may be used in any orientation. In a similar manner, the terms “upper” and “lower” provide relative positioning with respect to the “vertical” dimension, and the term “downwardly” provides direction from the upper in the direction of the lower. Further, “inwardly” and “outwardly” refer to “horizontal” directionality with respect to upper engaging surface 22, into harder component 10 and out from harder component 10, respectively.

Parallel to hard upper engaging surface 22 is a vertical, hard lower engaging surface 28. Hard lower engaging surface 28 is dispensed outwardly a distance k from hard upper engaging surface 22. Hard lower engaging surface 28 extends downwardly from a shelf edge 30. Shelf edge 30 is dispensed downwardly from hard-upper-engaging-surface end edge 26 a distance x. Shelf edge 30 is formed by lower engaging surface 28 and a horizontally extending ledge 32. Ledge 32 extends inwardly at least a distance k where it meets a concave surface 34. (For purposes of illustration of this particular embodiment, ledge 32 is depicted as perpendicular to lower engaging surface 28; inventors expressly observe that perpendicularity is not required of the invention for any surface of any angle or orientation which would allow for metal movement toward concave surface 34 is acceptable.) Concave surface 34 extends inwardly and upwardly into hard component 10 from ledge 32 to hard-upper-engaging-surface end point 26. Concave surface may be a groove undercut or cast circumferentially around cylinder. It is preferable that concave surface 34 is smooth and rounded to facilitate metal-on-metal motion along its surface.

Softer component 12 has a vertical soft upper engaging surface 36 and an intersecting horizontal lower surface 38. It is preferable that from the intersection of soft upper engaging surface 36 and lower surface 38 along lower surface 38 a distance of k, that lower surface 38 makes an angle with soft upper engaging surface 36 between 0° and 90°. While such angle is not crucial to the operation of this method, it will resist the tendency for the components 10, 12 to separate horizontally when placed under pressure.

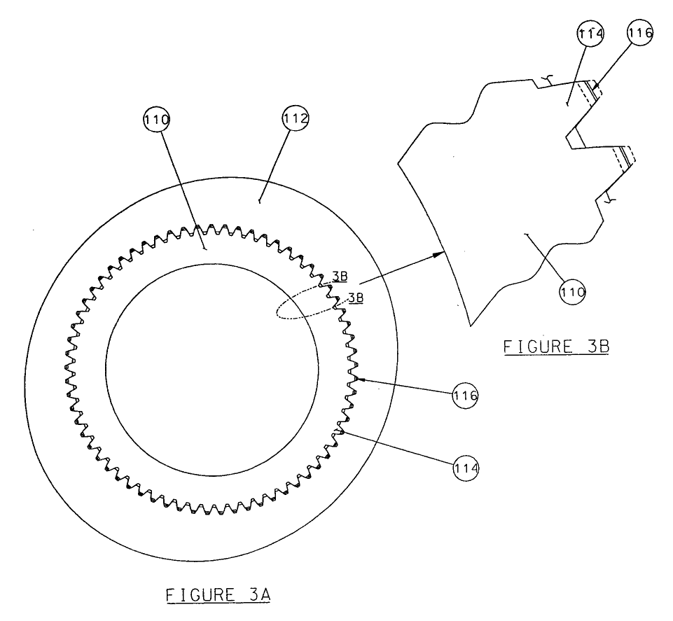

At the inception of the process, horizontal lower surface 38 is placed in contact with ledge 32 such that soft upper engaging surface 36 is placed in proximity or contact with upper engaging surface 22. The soft upper engaging surface 36 is kept in proximity or contact with upper engaging surface 22 either through external horizontal pressure as seen in FIG. 10 or through internal constraints dictated by the shape of softer component 12 as seen in example in FIG. 3 (e.g., the annular shape of the component 12 prevents horizontal motion of the soft upper engaging surface 36).

A downward axial force is applied to the upper surface 40 of the softer component 12 by a pressure source 42. The pressure source can be of an acute duration, such as by a swaging tool, or may be of a longer term, continuous variety.

As downward force is applied by pressure source 42 to upper surface 40 of softer component 12, the constraining force keeps vertical surface 36 horizontally juxtaposed with upper engaging surface 22, while lower surface 38 is forced into contact with ledge 32.

Due to the relative strength differences between harder component 10 and softer component 12, lower surface 38 of softer component 12 is cut by shelf edge 30 and ledge 32 of harder-metal component. Material of softer component 12 outward of shelf edge 30 will continue on down past ledge 32 along lower engaging surface 28. At the same time, material of softer component 12 inward of shelf edge 30 will be cut by shelf edge 30 and depending on the axial pressure, and the shear strength and tensile strength of softer component 12, will either be upturned by ledge 32 into concave cavity 44 adjacent to concave surface or will elastically flow into concave cavity 44.

Cavity 44 is dimensioned in a manner both necessary and sufficient to receive the full volume of material 46 cut from softer-metal component 12 as lower surface 38 outward of shelf edge 30 encounters press stop 48. Upper portion of cavity 44 adjacent to hard-engaging-surface end point 26 is configured to retain material 46 and thereby resist upward axial movement of disk-like softer component 12 relative to splined-hub harder component 10.

Referring to FIGS. 2B and 2C, air 50 located in cavity 44 is forced out of cavity 44 by incoming metal and up channel 52 formed between upper engaging surface 22 and soft upper engaging surface 36 due to slight dimensional differences to allow for relative motion as described above when components 10, 12 are under axial pressure. As pressure is applied to softer component 12 during the cutting by shelf edge 30, some horizontal deformation of vertical surface 36 occurs. Once lower surface 38 engages press stop 48, remaining pressure from pressure source 42 will cause further deformation of vertical surface 36 of softer component 12 above ledge 32. This coining forces a flexing of softer component 12 with coined portion 54 of vertical surface 36 entering into contact with upper engaging surface 22. Coining provides additional stability of the joint.

The method is particularly advantageous when practiced with splined components as shown in FIGS. 3A and 3B. Harder component 110 is a cylindrical hub and softer component 112 is an annular disk. Harder component 110 has axially running splines 114 along its entire engaging surface 22, 28 (better seen in FIG. 1). Splines 114 may run linearly axially or alternatively, with a rotation to produce helical splines. Softer component 112 has spline-receiving grooves 116. Such use with axial splines 114 on a hub 110 with an annular disk 112 would be particularly beneficial in the production of flywheel-containing driving hubs.

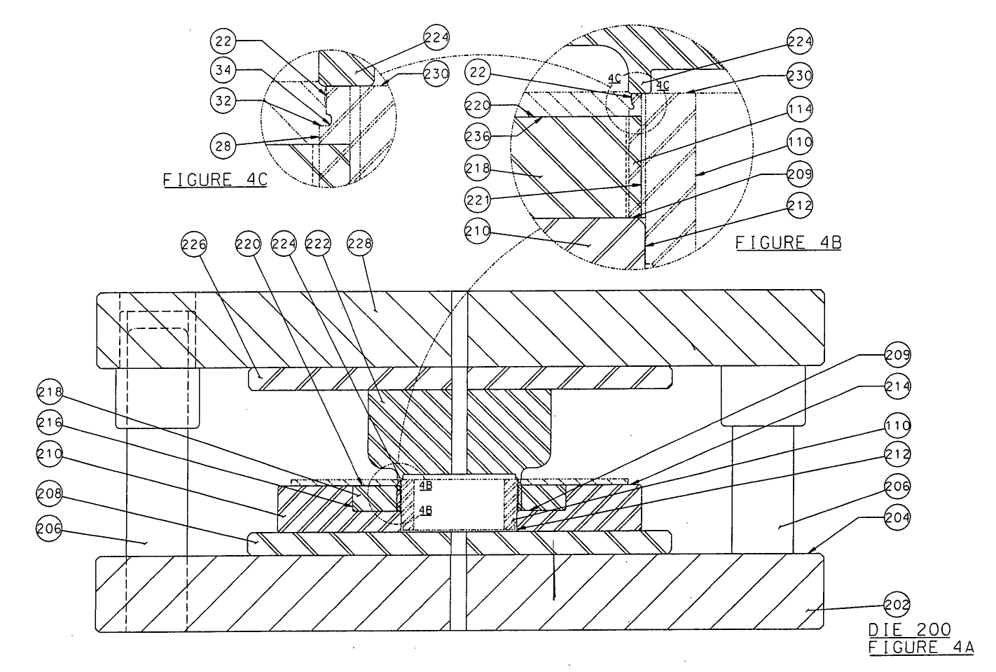

FIGS. 4A, 4B, and 4C are a cross-section of a tool/die 200 to accomplish the function of this particular method. Tool/die 200 must be substantial enough to withstand joining forces produced during the cold-joint process, while maintaining components in place. Tool/die 200 has a substantial die shoe 202 to anchor and stabilize tool/die 200 when in operation. Die shoe 202 has a horizontal die-shoe surface 204. Perpendicularly oriented to die-shoe surface 204 are tool/die travel guides 206. Tool/die travel guides 206 are most preferably leader pins and bushings. A lower spacer 208 rests on upper die-shoe surface 204. Harder-metal splined hub 110 sits on hub-seat surface 209, which is integral with, or sits on, lower spacer 208. Firmly attached to lower spacer 208 is an annular retention collar 210. Annular retention collar 210 has inner aperture 212 configured to receive hub 110.

Annular retention collar 210 has a collar upper surface 214. Annular retention collar 210 also has an annular recess 216. Snugly set within annular recess 216, is an annular anvil collar 218, such that an anvil collar upper surface 220 is coplanar with retention collar upper surface 214. Annular anvil collar 218 has a spline-receiving inner aperture to snugly engage splines 114 which extend partly along the outer surface of hub 110 (aperture and splines are better seen in FIGS. 1, 3A, 3B, and 4B).

Tool/die 200 has a punch body 222 with peening contacts 224. Punch body 222 is attached to an upper spacer 226, which in turn is attached to a tool/die top 228. Pressure from a pressure source (not shown) is applied to tool/die top 228. Pressure sources are well-known in the industry and include force generated from gravity-driven, mechanical, pneumatic, and hydraulic devices.

In operation, anvil collar 218 is secured to annular retention collar 210 in annular recess 216. In practice, hub 110 is placed into contact with tool/die 200 such that hub 110 is in slip-fit engagement with anvil collar 218 in a manner that is constrained horizontally and vertically. Hub 110 is placed in collar aperture 212 such that splines 114 engage spline-receiving aperture 221 such that upper engaging surface 22, ledge 32, concave surface 34, a portion of lower engaging surface 28, and hub upper surface 230 extend above anvil surface 220.

A soft-metal component, such as a fly wheel 112 with a fly wheel spline-receiving aperture (best seen in FIG. 3A) is positioned in touching engagement around hub 110 such that an inner ring of a flywheel lower surface 38 rests on ledge 32 (see FIG. 2A).

Pressure is applied to tool/die top 228 by source (not shown) thereby driving tool/die top 228 down along press travel guide 206.

As seen in FIGS. 2A, 2B, 2C, 4A, 4B, AND 4C, continued pressure causes upturning and inflow into cavity 34.

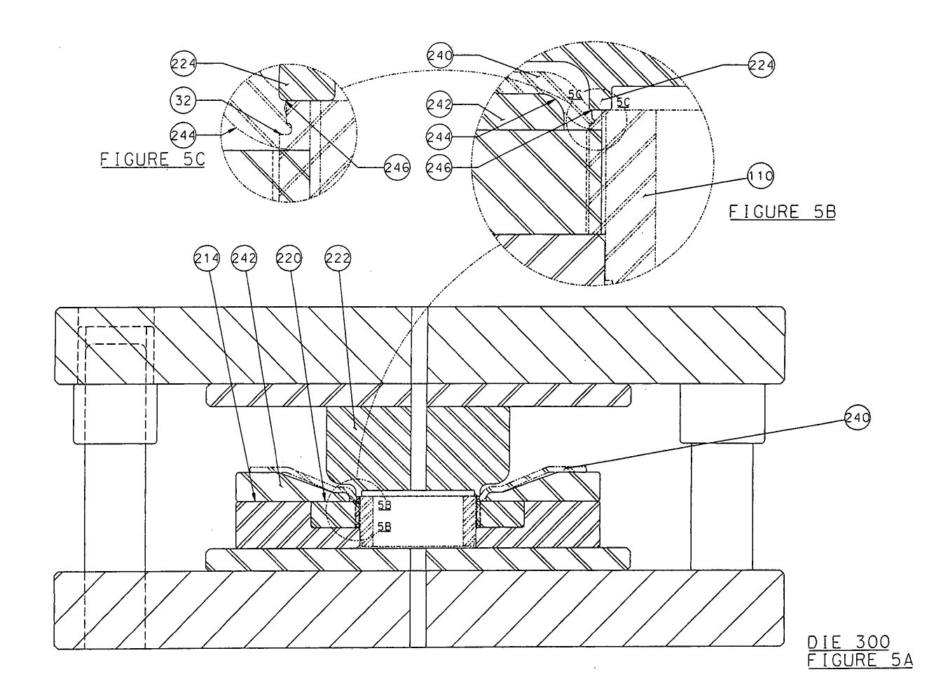

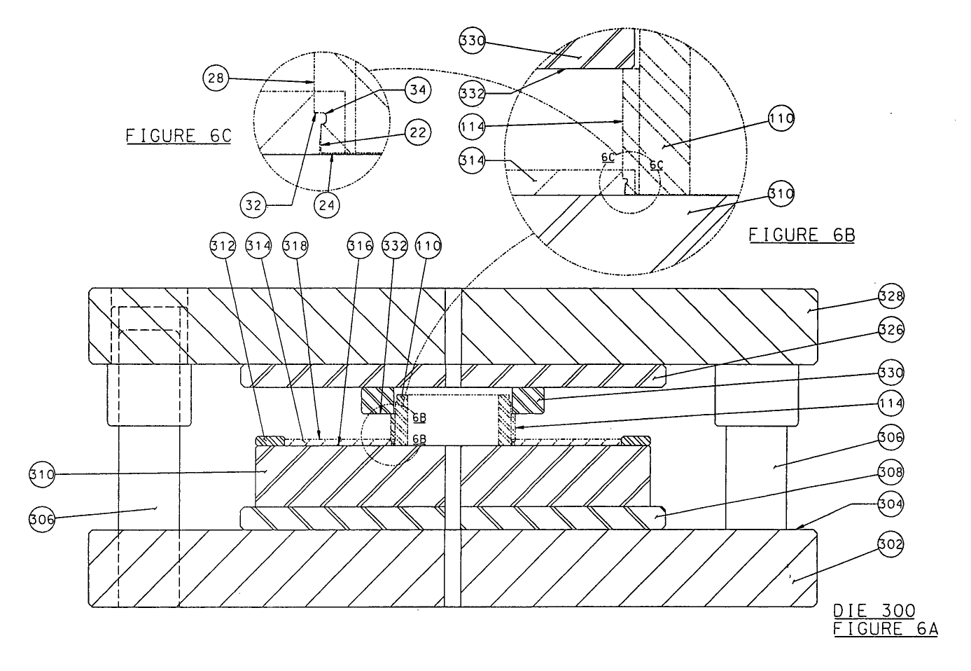

Pressure is then released, allowing tool/die top 228, to be retracted and the hub 110 with the flywheel 112 integrally joined, removed. As seen in FIGS. 5A, 5B, AND 5C, this soft-metal component may be a contoured flywheel 240 having a non-linear cross-section. In such cases, utilizing a contoured flywheel 240, contoured support 242 is inserted and secured, most typically by means of screws (not shown) between contoured flywheel 240 and the continuous horizontal planar surface of the anvil collar upper surface 220 and the collar upper surface 214. Contoured support 242 has a cross-sectional shape complimentary to contoured flywheel lower surface 244.

Peening contacts 224 strike contoured-flywheel upper surface 246 at points immediately above ledge 32.

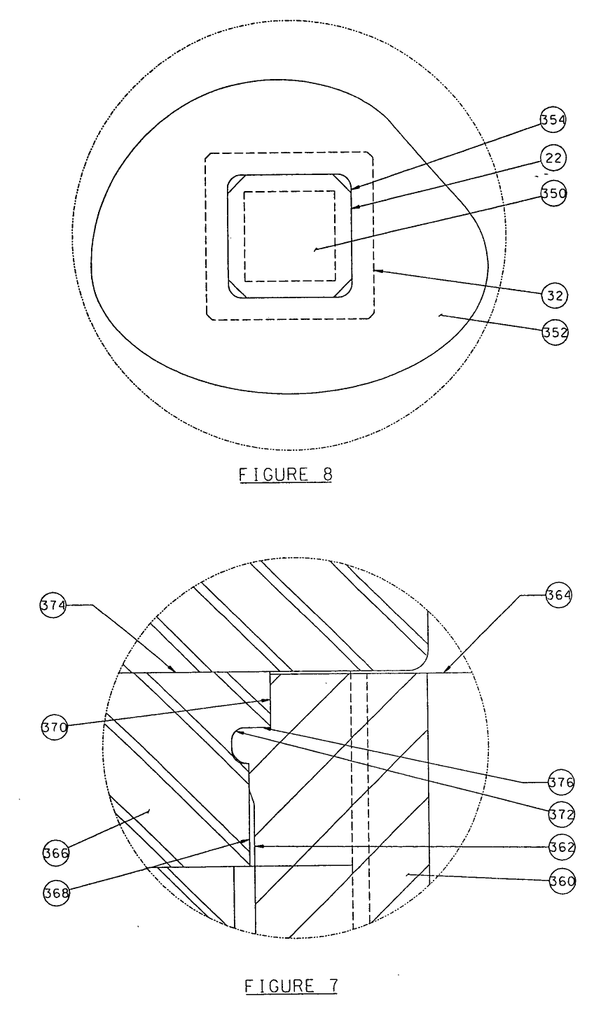

Although the method depicted in FIGS. 4A through 4C and 5A through 5C illustrate deforming pressure being applied through translation to the softer-metal component, as shown in FIGS. 6A through 6C and 7, pressure may be applied to the harder-metal component. FIG. 5A is a cross-section of tool/die 300 to accomplish the functions of this particular method. Tool/die 300 has a substantial die shoe 302 to anchor and stabilize tool/die 300 when in operation. Die shoe 302 has a horizontal die-shoe surface 304 perpendicularly oriented to die-shoe surface 304 are tool/die travel guide 306.

Secured to top spacer 308 is anvil base 310.

Annular flywheel-retention collar 312 extends around and is attached to, the disk-like anvil base 310 on anvil surface 316. Annular flywheel-retention collar 312 describes a large circular interior void dimensional to accommodate and retain annular flywheel 314 when flywheel 314 is laid on planar horizontal anvil-base upper surface 316 in the void. Splined hub 110 is of the same type as described above having upper engaging surface 22, horizontal top surface 24, lower engaging surface 28, ledge 32, and concave surface 34. As seen best in FIG. 6C, the hard-metal hub 110 is inverted relative to the illustrations in FIGS. 4A through 4C and 5A through 5C.

When placed in tool/die 300, inverted-hub ledge 32 is placed in contact with flywheel upper surface 318. For purposes of clarification, Applicants have described component 318 as “upper” as relative to the tool/die, this is the upper surface of the flywheel. Applicants recognize that use of the term “upper” with respect to component 318 is diametrically opposite to its description of upper surface in component 236 when describing tool/dies 200.

An upper spacer 326 is attached to a tool/die top 328. Spacers 308, 326 are configured to have a thickness to assure that when pressure is applied to tool/die top 328, vertical travel along travel guides 306 will be no more than is necessary and sufficient to obtain proper deformation at the junction and allow for upturning and in flow into cavity 34. Pressure from pressure source (not shown) is applied to tool/die top 328 and translated thereto through spacer 326 to spline-block ring 330. Spline-block ring 330 has a lower surface 332 configured to engage the lower surface of spline 114.

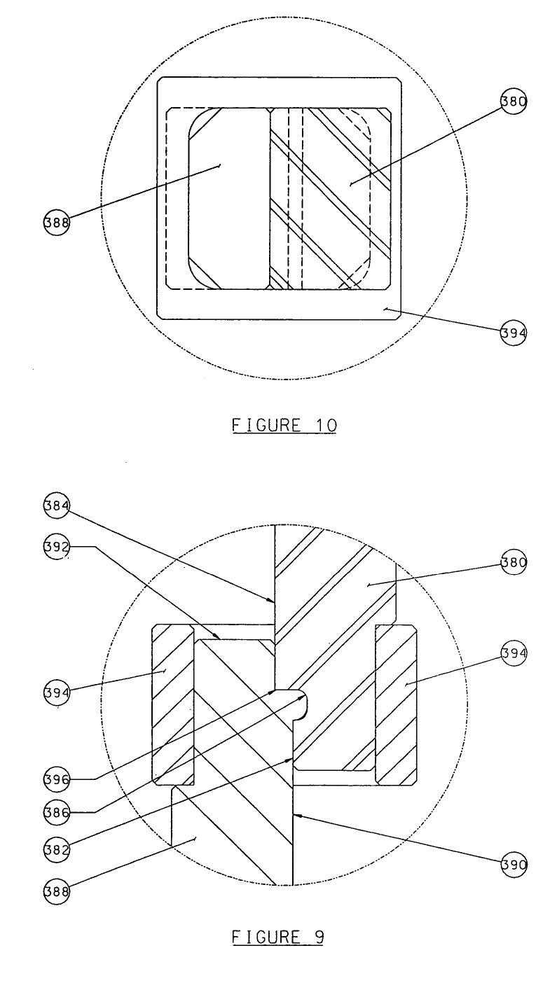

Neither the hub nor flywheel portion are required to have circular cross-sections. As seen in FIG. 8, the hub 350 is a shaft with square cross-section. As described with respect to FIGS. 2A, 2B and 2C, hub 350 has ledge 32 (shown in phantom) and upper engaging surface 22.

Softer-metal flywheel 352 may be of any configuration. For illustration purposes, softer-metal flywheel 352 is an irregular annular disk. As will be seen, while it is not necessary for one of the components-to-be-joined to be annular, by using annular flywheel, no horizontal confining force is needed when vertical (axial) joining force is applied.

Annular flywheel 352 has a flywheel aperture 354 complementary in shape to hub upper surface periphery 22.

While vertical joining force is applied in tool/die 200 shown in FIGS. 4A, 4B, and 4C, to flywheel 352, flywheel 352 is forced onto and cut by ledge 32.

A hub-flywheel connection may be made by this method, regardless of whether the hub is of the harder or softer metal. As seen in FIG. 7, soft-metal cylindrical hub 360 has an exterior surface 362 which is uniform and parallel to an axis of hub 360 and has upper surface 364. Hard-metal flywheel 366 has leading annular vertical wall 368 and trailing annular vertical wall 370 with annular retaining groove 372 located there between. Hub upper surface 364 is first placed in contact with a ledge 376 such that exterior surface 362 is contiguous to leading annular vertical wall 368. Force is imparted to flywheel upper surface 374. Ledge 376 cuts and upturns a portion of soft-metal hub 360 into retaining groove 372.

The method may also be used to join two metals of different hardnesses along a common boundary. As seen in FIG. 9, hard-metal component 380 has a planar leading wall 382, a planar trailing wall 384, with a linear retention groove 386 located there between.

A soft-metal component 388 has a planar face 390 and a horizontal surface 392. Planar face 390 is confined into contact with leading wall 382 while vertical motion-producing force moves soft-metal component 388 with respect to hard-metal component 380 along leading wall/planar face interface, through a retention frame 394 (as better seen in FIG. 10). As soft-metal component 388 moves, ledge 396 cuts metal from softer metal component 388 and upturns cut metal into linear retention groove 386.

While the principles of this invention have been described in connection with specific embodiments, it should be understood clearly that these descriptions are made only by way of example and are not intended to limit the scope of the invention.

1. A method for joining, by axial movement, inner and outer metal pieces having outward and inward juncture surfaces, respectively, each piece having a different hardness, the method comprising:
forming the harder piece to have a radial groove in its juncture surface and leading and trailing portions, respectively, on either side of the groove, the leading portion being dimensioned to slide with respect to the softer piece and the trailing portion being dimensioned for swaging interference with the softer piece;
imparting relative male-female axial movement of the pieces, the softer piece along the leading portion of the harder piece until the softer piece engages the trailing portion of the harder piece;
applying relative axial force for continued axial movement whereby the softer piece passes the groove such that swaging interference causes a portion of the softer piece to be upset into the groove,
thereby creating a permanent joint between the pieces.

2. The method of claim 1 wherein the harder piece is formed to be the inner piece.

3. The method of claim 2 wherein the force-applying step is further comprised of:
fixing the relative position of the inner piece, and
applying axial force to the outer piece.

4. The method of claim 2 wherein the force-applying step is further comprised of:
fixing the relative position of the outer piece, and
applying axial force to the inner piece.

5. The method of claim 2 wherein the outward and inward juncture surfaces have a substantially circular radial cross-section.

6. The method of claim 1 wherein the harder piece is formed to be the outer piece.

7. The method of claim 6 wherein the force-applying step is further comprised of:
fixing the relative position of the inner piece, and
applying axial force to the outer piece.

8. The method of claim 6 wherein the force-applying step is further comprised of:
fixing the relative position of the outer piece, and
applying axial force to the inner piece.

9. The method of claim 6 wherein the outward and inward juncture surfaces have a substantially circular radial cross-section.

10. A method for joining a cylinder of a first metal of a first hardness to a second-metal component of a second hardness, the second hardness less than the first hardness, the method comprising:
providing the cylinder of the first metal having:
an axis;
a proximal section with a radial cross-sectional shape of a first dimension;
a distal section of the radial cross-sectional shape, said distal section of a second dimension greater than the first dimension; and
a groove section of the radial cross-sectional shape, said groove section of a third dimension less than the first dimension, said groove section located between the proximal section and the distal section, thereby defining a ledge with a sharp, discrete edge at a line of juncture between the groove section and the distal section and further thereby defining a groove;
providing the second-metal component defining an aperture of the radial cross-sectional shape, said aperture of a dimension greater than the first dimension and less than the second dimension, said second-metal component having:
a radial dimension greater than the second dimension;
an upper surface; and
a lower surface;
mounting the second-metal component onto the cylinder such that a portion of the first section is located within the aperture and such that the lower surface is distal to the upper surface proximal to the ledge; and
applying axial force to move the cylinder with respect to the second-metal component such that the lower surface is urged distally to a position distal to the groove section;
thereby allowing the ledge to cut an interior portion of the second-metal component adjacent to the aperture, and allowing the ledge to upset the cut interior portion into the groove creating a joint.

11. The method of claim 10 wherein the axial force is applied with respect to the upper surface.

12. The method of claim 10 wherein the axial force is applied with respect to the distal section of the cylinder.

13. The method of claim 10 wherein the radial cross-sectional shape is generally circular.

14. The method of claim 13 wherein the cylinder is a hub with longitudinal splines extending along at least a portion of the proximal section and extending along at least a portion of the distal section, such that the splines maintain a regular radial distance from the axis, and wherein the second-metal component further defines spline-receiving slots extending radially out from the aperture configured and arranged to be complementary to the splines when the second-metal component is mounted on the cylinder.

15. The method of claim 14 wherein the longitudinal splines are helical.

16. The method of claim 13 wherein the second-metal component is a disk.

17. The method of claim 10 wherein the groove has a longitudinal cross-section which is bulbous with a larger end interior to a narrow end.

18. The method of claim 17 wherein the groove section is configured and arranged to direct the interior portion of the second-metal component upset by the ledge into compact and filling engagement with the groove.

19. A method for joining a cylinder of a first metal of a first hardness having a to a second-metal component of a second hardness, the second hardness greater than the first hardness, the method comprising:
providing the cylinder of the first metal having:
an axis;
a radial cross-sectional shape of a first dimension;
an exterior surface;
a proximal end; and
a distal end
providing the second-metal component defining an aperture of the radial cross-sectional shape, said second-metal component having:
an upper surface;
a lower surface;
an aperture wall extending longitudinally adjacent to the aperture from the upper surface to the lower surface, said aperture wall having:
an upper section of the radial cross-sectional shape with a second dimension greater than the first dimension extending from the upper surface toward the lower surface;
a lower section of the radial cross-sectional shape with a third dimension less than the first dimension extending from the lower surface toward the upper surface; and
a groove section of the radial cross-sectional shape, said groove section of a fourth dimension greater than the second dimension, said groove section extending between the upper section and the lower section, thereby defining a ledge with a sharp, discrete edge at a line of juncture between the groove section and the lower section and further thereby defining a groove;
mounting the second-metal component onto the proximal end of the cylinder such that the proximal end of the cylinder is located within the upper section of the aperture and such that the upper surface is oriented toward the distal end; and
applying axial force to move the cylinder with respect to the second-metal component such that the upper surface is urged distally;
thereby allowing the ledge to cut a portion of exterior surface of the cylinder, and allowing the ledge to upset the cut portion of the exterior surface into the groove creating a joint.

20. The method of claim 19 wherein the axial force is applied with respect to the lower surface.

21. The method of claim 19 wherein the axial force is applied with respect to the distal end of the cylinder.

22. The method of claim 19 wherein the radial cross-sectional shape is generally circular.

23. The method of claim 22 wherein the cylinder further has longitudinal splines extending along at least a portion of an exterior surface of the cylinder, such that the splines maintain a regular radial distance from the axis, and wherein the second-metal component further defines spline-receiving slots extending radially out from the aperture, configured and arranged to be complementary to the splines when the second-metal component is mounted on the cylinder.

24. The method of claim 23 wherein the longitudinal splines are helical.

25. The method of claim 22 wherein the second-metal component is a disk.

26. The method of claim 19 wherein the groove has a longitudinal cross-section which is bulbous with a larger end interior to a narrow end.

27. The method of claim 26 wherein the groove is configured and arranged to direct the portion of the exterior surface upset by the ledge into compact and filling engagement with the groove.

28. A method for joining a first-metal component of a first hardness to a second-metal component of a second lesser hardness, the method comprising:
providing a first wall on the first-metal component, having: first and second edges; a smooth first surface extending from the first edge toward the second edge along a straight direction of travel; a smooth second surface extending from the second edge toward the first edge along the same direction of travel, the second surface being parallel to and offset from the first surface, thereby creating a shoulder; and a groove between the first and second surfaces;
providing a second wall on the second-metal component, having a straight smooth third surface and a fore edge;
placing the third surface in contact with the first surface such that the fore edge is located between the first edge and the shoulder;
continually forcing the first-metal and second-metal components together such that the third and first surfaces remain in contact; and
while such continued contact force is applied, applying sliding force to impart relative sliding motion of the first-metal and second-metal components along the direction of travel such that the fore edge is urged toward the second edge to a position beyond the groove, thereby causing the shoulder to upset a portion of the second-metal component into the groove;
whereby the first-metal and second-metal components are fixed in their relative positions along the direction of travel.
